(19) United States
(12) Patent Application Publication
(10) Pub. No.: US 2005/0011468 A1
(43) Pub. Date: Jan. 20, 2005

(54) Use of methylnaltrexone in treating gastrointestinal dysfunction in equines

(76) Inventor: Jonathan Moss, Chicago, IL (US)

Correspondence Address: ROTHWELL, FIGG, ERNST & MANBECK, P.C., 1425 K STREET, N.W., SUITE 800, WASHINGTON, DC, 20005, US

(21) Appl. No.: 10/917,412

(22) Filed: Aug. 13, 2004

Related U.S. Application Data
(63) Continuation-in-part of application No. 10/493,568, filed on May 12, 2004.
(60) Provisional application No. 60/354,278, filed on Feb. 4, 2002.

(51) Int. Cl. B68B 1/06

(52) U.S. Cl. 119/651

(57) ABSTRACT

Systems and methods are described for using methylnaltrexone to treat or prevent inhibition of gastrointestinal motility in equines. A method for preventing or treating opioid-induced and non-opioid-induced gastrointestinal dysfunction includes administering a quaternary derivative of noroxymorphone, preferably methylnaltrexone, to an equine before or after the onset of the gastrointestinal dysfunction.

### CROSS-REFERENCE TO RELATED APPLICATIONS

This application is a continuation-in-part of U.S. Ser. No. 10/493,568, filed Apr. 26, 2004, which is a 371 application of PCT/US02/34458, filed Oct. 28, 2002, which claims the benefit of priority under 35 U.S.C. §119(e) to U.S. Ser. No. 60/354,278, filed Feb. 4, 2002, the entire contents of which are hereby expressly incorporated by reference for all purposes.

### FIELD OF THE INVENTION

The invention relates generally to the field of equine medicine. More particularly, the invention relates to the treatment or prevention of gastrointestinal dysfunction in an equine.

### BACKGROUND OF THE INVENTION

The inventory of equines in the United States as of Jan. 1, 1999 totaled 5.32 million head, up 1.3 percent from the 5.25 million head on Jan. 1, 1998. Inventory at the start of 2002 is just shy of 5.5 million head. Alternative reports suggest as many as 6.9 million horses in North America. Equine includes horses, ponies, mules, burros, and donkeys. Texas ranked first in equine inventory with 600,000 head followed by California, and Tennessee with 240,000 and 190,000 head, respectively. Florida, Oklahoma, and Pennsylvania tied for fourth with an inventory of 170,000 head. Ohio ranked seventh with 160,000 head, followed by Kentucky, Minnesota, New York, and Washington with 155,000 head. An additional fifteen states had equine inventories of 100,000 head or more.

Equine located on farms total approximately 60% while non-farm animals accounted for 39.1 percent of the total. Non-farm horses are used for recreation (>40%), showing (<30%), racing (˜10%) and other purposes such as hunting (˜18%).

The total economic impact due to the U.S. horse industry approaches $112 billion. More than 7 million Americans are involved in the horse industry, including approximately 2 million owners of horses. This industry supports more than a million jobs and pays into federal, state and local governments almost $2 billion in taxes. Value of sales from equine sold in 1998 was $1.75 billion, up 6.9 percent from of $1.64 billion in 1997. The top ten states for equine sales were Kentucky, Florida, Texas, California, Virginia, New Jersey, Tennessee, New York, Pennsylvania, and Maryland.

Horses are highly susceptible to gastrointestinal distress, in particular, gastrointestinal (GI) hypoperistalsis. GI hypoperistalsis may occur in several forms in equines as well as other animals, the most notable of these forms include colic and post-operative ileus. Post-operative ileus is a widely known phenomenon, oftentimes appearing on a vet's post-operative checklist for vital signs as a colic scale, alongside checkpoints for pulse and blood pressure. In addition, post-operative ileus is the cause of 90% of deaths after abdominal surgery in equines.

The inhibition of equine gastrointestinal motility, such as colic and constipation, may be fatal to a horse. The pain suffered by the horse who has colic is enough to send the animal into a death-inducing shock, while a long-term case of constipation may also cause the horse's death.

The main causes of colic are intestinal distension and reduced blood supply to the intestinal tract. Peristalsis of the intestine is reduced and distention will occur due to reduced movement and absorption of water and nutrients. The pressure that results from this lack of passage of material through the digestive system results in a reflex action, which causes adjoining areas to contract in spasm. Distension and reduced blood flow may be due to an accumulation of gas fluid or feed, digestive disturbances, intestinal obstructions, internal parasites, or twisted intestine (torsion and volvulus). A horse constantly swallowing air or “wind sucking” may cause chronic distension.

The primary cause of the abdominal pain is this distention. Pain is also produced when the peritoneum is stretched during attacks of colic. The first response the body makes to distension is to increase the secretion of digestive juices, which increases the pressure, and causes dehydration and imbalance in the chemical systems of the body. This can often become a feedback reaction leading to shock, which must be treated as a separate syndrome, since it is frequently the cause of colic deaths. The paralysis of the intestine also allows toxic material to escape through the stretched walls and enter the abdominal cavity, where the horse can be poisoned by his own intestinal contents.

Veterinarians often perform a rectal exam; intestinal contents and their position can indicate to the veterinarian presence or absence of intestinal motility and the location of the obstruction or impact. A stomach tube may be used to collect stomach contents or gas to help the veterinarian decide the type of disorder and the severity of the condition. Other symptom the vet will note include pulse (rate should be less than 80 per minute for a favorable prognosis), temperature, presence or absence of intestinal sounds. Generally, the prognosis is excellent when pain is due to excessive activity of the intestines, good for pain due to impaction, and very poor for pain caused by twisting or intussusception of the intestines (unless surgery is immediate).

In preliminary studies of the use of plasma β endorphin as an indicator of stress and pain, McCarthy, et al., Journal of Veterinary Science 13(4): 1993 demonstrate that normal levels of β endorphin in equines are well under 10 pmol ml. During gaseous or intestinal colic, the level rises to 669 and 604 pg/ml. Thus, visceral pain is associated with marked elevations of β endorphin. This is in contrast to chronic musculoskeletal disorders where the level of endorphins only rises to relatively modest levels. In addition, transport of equines, particularly by air travel, leads to sustained elevations of plasma endorphins which in fact correlate well with the gastrointestinal changes that are seen. The IC₅₀ of equine endorphin on the standard model of gut motility is given as 12.3 nmol. This translates to 12.3 pmol ml. and thereby demonstrates that levels seen during equine colic are sufficient to induce inhibition of peristalsis of the gut and to inhibit gastric emptying. In one study of the peripheral opioid activity of homologues from six species, it was noted that the IC₅₀ for equines is 12.3 nmol, while that of humans is 12.2. See Ho C. L., et al., “B-endorphin: peripheral opioid activity of homologues from six species,” Int. J. Peptide Protein Res. 29:521-524, 1987. In addition to endorphins, enkephalins with mu (μ) activity are also relevant in the gut.

Recent human data support the role of endogenous opioids, including endorphins, in the pathogenesis of postoperative ileus in humans. See Taguchi A., et al., “Selective postoperative inhibition of gastrointestinal opioid receptors,” New Engl. J. Med. 345:935-40, 2001. No reference is made to either equine colic or the etiology of perioperative management of equines or other animals. In one case of postoperative colic in a bum patient who was treated with methylnaltrexone, the infusion of methylnaltrexone 0.3 mg/kg over 15 minutes induced prompt restoration of bowel sounds and flatus during drug administration. Prior to administration, there had been no evidence of bowel peristalsis and no passage of flatus. See Moss J., et al., “Selective postoperative inhibition of gastrointestinal opioid receptors,” (correspondence) New Engl. J. Med. 346(6):455 (2002). These prompt results and temporal relationship demonstrated methylnaltrexone's immediate and direct effect in treating the patient's ileus. In addition, gastric residuals, which are a function of gastric emptying and are an important component of the bloating which is seen in equine colic, were markedly reduced following administration of the drug (unpublished data).

Current treatments for horse colic are not effective. These include the use of a stomach tube to relieve gas pressure on the horse's stomach and giving antacid-antigas type medications (e.g., Maalox). Mineral oil may be administered via stomach tube to loosen the blockage. However, side effects of the use of mineral oil are depletion of stored vitamins and the blockage of vitamin absorption in the horse's stomach. Surgery is the final treatment in cases of severe colic. The risks and expense inherent in large animal surgeries makes this a treatment reserved for commercially important animals and only a few individual owners. When treating horses for opioid-related conditions, such as post-operative ileus, the medications used to treat the constipation resulting from opioid medication reduces the painkilling effects of the medication, which could result in shock and the horse's death.

Heretofore, the needs for an agent to treat or prevent opioid-induced side effects and to treat non-opioid related gastrointestinal motility problems have not been fully met. What is needed is a solution that addresses all of these requirements.

### SUMMARY OF THE INVENTION

According to an aspect of the invention, there is provided a method for treating opioid induced gastrointestinal dysfunction comprising administering a peripheral opiate antagonist, and preferably a quaternary derivative of noroxymorphone, to an equine after the onset of the gastrointestinal dysfunction. According to another aspect of the invention, a method for preventing opioid induced gastrointestinal dysfunction comprising administering a peripheral opiate antagonist, and preferably a quaternary derivative of noroxymorphone to an equine, before the onset of the gastrointestinal dysfunction is provided. In a preferred embodiment, the quaternary derivative is methylnaltrexone. Administration can be by intravenous, intramuscular, transmucosal, transdermal, subcutaneous, epidural, spinal, peritoneal, or oral administration.

According to yet another aspect of the invention, a method is provided for treating non-opioid induced gastrointestinal dysfunction comprising administering preferably a quaternary derivative of noroxymorphone to an equine after the onset of the gastrointestinal dysfunction. According to another aspect of the invention, a method for preventing non-opioid induced gastrointestinal dysfunction comprising administering a quaternary derivative of noroxymorphone to an equine before the onset of the gastrointestinal dysfunction is provided. The quaternary derivative preferably is methylnaltrexone, which can be administered by intravenous, intramuscular, transmucosal, transdermal, subcutaneous, epidural, spinal, peritoneal, or oral administration.

The methylnaltrexone can be formulated with saline for administration by intravenous, intramuscular or subcutaneous administrations, or with a pharmacologically acceptable carrier, and can be administered over a suitable time period at a dosage of 0.05 to 40.0 mg of active drug per kg body weight. The methylnaltrexone can also be an enterically coated methylnaltrexone that is administered at a dosage of 0.05 to 40.0 mg of active drug per kg body weight. The enterically coated methylnaltrexone can also be administered orally at a dosage of about 0.1 to about 10 mg/kg body weight as an enterically coated tablet or capsule, or as enterically coated granules, where the enteric coating provides time release of the methylnaltrexone.

In a preferred aspect of the invention, a method is provided for treating or preventing gastrointestinal dysfunction in an equine induced by elevated concentrations of endogenous opioids, while maintaining the pain-reducing effects of the opioids. The method comprises administering an effective amount of, preferably, methylnaltrexone to the equine before or after the onset of the gastrointestinal dysfunction, thereby treating or preventing, respectively, the gastrointestinal dysfunction without precipitating pain in the equine.

In a preferred embodiment, methylnaltrexone is administered intravenously, intramuscularly, or subcutaneously, and more preferably is administered subcutaneously.

In another preferred embodiment, methylnaltrexone is administered at a dosage of 0.05 to 40.0 mg of active drug per kg body weight.

Types of gastrointestinal dysfunction which may be treated or prevented according to this invention include constipation or reduced frequency of laxation, delayed gastric emptying and resultant reflux caused by such delay, equine colic, post-operative ileus, and grass sickness.

In another embodiment, the gastrointestinal dysfunction treated or prevented according to the invention may be induced by elevated concentrations of endogenous opioids which occur during transport of the animal.

In another embodiment, the invention provides a method for relieving inhibition of gastrointestinal motility in an equine induced by elevated concentrations of endogenous opioids, while maintaining the pain-reducing effects of the opioids. The method comprises administering an effective amount of, preferably, methylnaltrexone to the equine, thereby relieving the inhibition of gastrointestinal motility without precipitating pain in the equine.

In still another embodiment, the invention provides a method for minimizing the onset of side effects induced by elevated concentrations of endogenous opioids in an equine, while maintaining the pain-reducing effects of the opioids. This embodiment comprises administering an effective amount of, preferably, methylnaltrexone to the equine. Possible side effects include shock.

In still another embodiment, the invention provides a method for treating or preventing inhibition of gastrointestinal motility induced by elevated concentrations of endogenous opioids in an equine during transport of the equine, while maintaining the pain-reducing effects of the opioids. This embodiment also comprises administering an effective amount of, preferably, methylnaltrexone to the equine, thereby treating or preventing the inhibition of gastrointestinal motility.

These, and other, embodiments of the invention will be better appreciated and understood when considered in conjunction with the following description and the accompanying drawings.

### BRIEF DESCRIPTION OF THE FIGURES

FIG. 1 is a graph showing mean plasma β-endorphin levels (pmol ml⁻¹±SEM) before, during, and after application of an upper lip twitch stimulus in six horses.

FIG. 2 shows the chemical structure of methylnaltrexone (MNTX).

### DETAILED DESCRIPTION OF THE INVENTION

The invention and its various features and advantages are explained more fully with reference to the nonlimiting embodiments that are illustrated in the accompanying drawings and detailed in the following description. Various substitutions, modifications, additions and/or rearrangements within the spirit and/or scope of the underlying inventive concept will become apparent to those skilled in the art from this disclosure.

I. Colic and Other Gastrointestinal Dysfunctions

Some form of colic affects approximately 10% of horses every year. The main causes of colic are intestinal distension and reduced blood supply to the intestinal tract. Peristalsis of the intestine is reduced and distention will occur due to reduced movement and absorption of water and nutrients. The pressure that results from this lack of passage of material through the digestive system results in a reflex action, which causes adjoining areas to contract in spasm. Distension and reduced blood flow may be due to an accumulation of gas fluid or feed, digestive disturbances, intestinal obstructions, internal parasites, or twisted intestine (torsion and volvulus). A horse constantly swallowing air or “wind sucking” may cause chronic distension that may lead to colic.

The primary cause of the abdominal pain is this distention. Pain is also produced when the peritoneum is stretched during attacks of colic. The first response the body makes to distension is to increase the secretion of digestive juices, which increases the pressure, and causes dehydration and imbalance in the chemical systems of the body. This can often become a feedback reaction which can lead to shock, which must be treated as a separate syndrome by the vet, since it is frequently the cause of colic deaths. The paralysis of the intestine also allows toxic material to escape through the stretched walls and enter the abdominal cavity, where the horse can be poisoned by his own intestinal contents.

There are various causes of colic and since the prognosis and treatment varies greatly with each, early recognition and accurate determination of what type of colic the horse is experiencing is very important.

This invention identifies a novel approach to treating colic and other gastrointestinal motility problems in animals using, preferably, methylnaltrexone (MTNX). In one embodiment of the invention, this method is used in treating equine colic, a disorder that affects approximately 10% of horses annually. It also has alternate applications for treating grass sickness, post-operative ileus and laminitis in horses. MTNX is a peripheral opiate antagonist under development for human health applications by Progenics (Tarrytown, N.Y.).

II. μ-Receptors and β-Endorphins

μ-receptors are responsible for analgesia, and for the classical or morphine-like side effects of opioids. Only a small percentage of these receptors need to be occupied in order to produce analgesia. μ-receptors are clustered in the cerebral cortex, some regions of the thalamus, and in the periaqueductal grey region of the spinal cord. They are also found in large amounts in the gut.

Some experts believe that μ-receptors should be divided into two sub-groups. μl receptors have a high affinity for opioids, and are associated with analgesia. μ2 receptors have a low affinity for opioids and are associated with respiratory depression and, probably, the development of physical dependence.

MNTX is able to counteract the negative gastrointestinal effects of opioids while not decreasing the pain-reducing effects of the opioids. This is especially important when applied to equines.

Another characteristic of morphine in relation to equines, and possibly other animals, is that morphine can send the horse into sudden rage. Conventional treatments with anti-opioid compounds have been unsuccessful, possibly due to central μ-receptors. MNTX has been shown to minimize the severity of the morphine-induced rage in an animal.

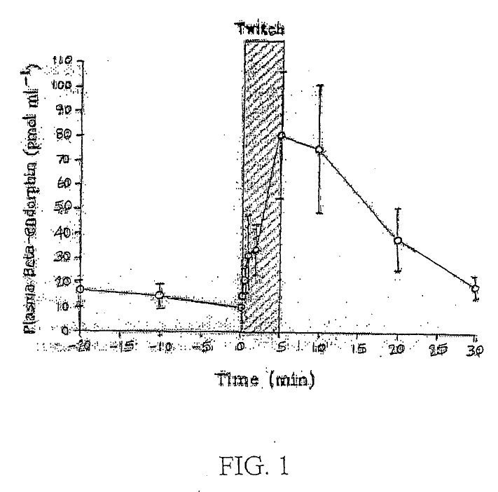

It has been shown in horses that the amount of immunoreactive β-endorphin concentration (ir β-EP) in their plasma rises dramatically when the horse is exposed to pain, such as severe abdominal pain stemming from conditions such as colic, fright, and surgical procedures. In one study, a lip twitch was applied to the muzzles of six horses for 5 minutes, and their β-EP levels were measured during the 5 minutes and for 30 minutes after the twitch was removed. The results from this study is shown in FIG. 1.

β-EP is an endogenous opioid released primarily from the adenohypophysis after post-translational differential processing of pro-opiomelanocortin (POMC). β-EP is known to be hypotensive, possibly by acting on a serotonergic pathway, and thus possibly contributing to shock. High levels of plasma β-endorphin (β-EP) levels have been associated with cardiogenic shock and endotoxemia.

Any increase in pain and stress can elevate plasma concentrations of β-EP. It has been shown that prolonged air transportation of the horse can result in sustained elevation of plasma concentrations of ir β-EP. A surgical procedure on as localized an area as a horse's eye is also enough to elevate ir β-EP levels to extremely high levels that may prove dangerous to the horse. Horses suffering from colic showed marked elevations in plasma concentrations of ir β-EP, which may have contributed to death-causing shock.

Therefore, for conditions such as post-operative ileus, the administration of MNTX can aid in decreasing the onset of shock due to gastric dysmotility caused by elevated concentrations of endogenous opioids, including endorphins. By attaching to the μ-receptors, the risk of β-EP induced shock may be minimized.

III. Methylnaltrexone

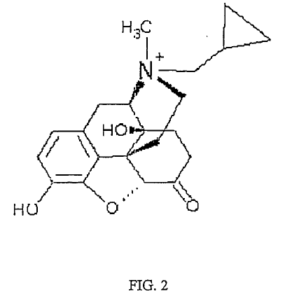

Methylnaltrexone is a quaternary amine derivative of naltrexone and a quaternary derivative of noroxymorphone, the structure of which is shown in FIG. 2. Methylnaltrexone has been found to have only 2 to 4% of the opiate antagonistic activity of naltrexone in vivo due to its inability to pass the blood-brain-barrier and bind to the opiate receptors in the central nervous system.

MNTX has been proven for use in humans in either the enterically coated form or in order to prevent or treat opioid induced side effects including dysphoria, pruritus, and urinary retention and non-opioid induced changes in gastrointestinal motility in patients. MNTX does not cross the blood-brain-barrier, and does not interfere for brain-centered relief nor does it irritate the horse to the point of risking injury to itself or its handlers.

MNTX is a specific peripheral opioid antagonist. It acts by binding to opioid receptors without activating them, thus competing with the binding of opioid drugs. MNTX targets μ-receptors, the same receptors that are targeted by opioids. MNTX is designed to block opioid side effects in the peripheral tissues of the body without interfering with the ability of opioids to relieve pain via the central nervous system.

When used as a treatment in humans for opioid- and nonopioid-induced side effects, orally administered, particularly if enteric coated, methylnaltrexone (MNTX) or other quaternary derivatives of noroxymorphone (QDMN) provides prolonged relief of the side effects. During treatment or prevention of delayed gastric emptying from enteric feeding and constipation, whether caused by extrinsic or endogenous opioids, the use of enteric coating in humans surprisingly allows for equal or better efficacy despite lower plasma levels. Idiopathic constipation, i.e., constipation that is due to causes other than exogenous administration of opioids, may be mediated by opioid sensitive mechanisms.

Although oral administration to an equine is an embodiment of the invention, parenteral administration, preferably intravenous, intramuscular, mucosal and subcutaneous administration, and more preferably, subcutaneous administration, should have advantages for administering MNTX to an equine.

Endogenous opioid receptors have been identified in the gut, and these receptors may modulate gut motility. Thus, administration to an equine of an opioid antagonist with peripheral action, such a methylnaltrexone or other quaternary derivatives of noroxymorphone, would block the effects of endogenous opioids.

MNTX can gain access to opioid receptors located in the gastrointestinal tract via both direct luminal access and through the plasma, thus preventing opioids from binding to these receptors and affecting gastrointestinal function.

MNTX does not, however, attach to μ receptors in the brain, because it was designed not to cross, or cross to a lesser extent, the blood-brain barrier by lowering its lipid solubility as compared to naltrexone. This is made possible by the formation of quaternary nitrogen wherein an additional methyl group is attached to the naltrexone molecule. This confers a net positive charge on the molecule and limits its ability to diffuse freely through the blood-brain barrier.

A. Enterically-Coated MNTX

In one embodiment for the prevention and/or treatment of constipation and inhibition of gastrointestinal motility, the QDNM or MNTX is enterically coated and administered orally. For oral administration, the QDNM or MNTX is formulated with pharmacologically acceptable binders to make a tablet or capsule with an enteric coating. An enteric coating is one which remains intact during passage through the stomach, but dissolves and releases the contents of the tablet or capsule once it reaches the small intestine. Most currently used enteric coatings are those which will not dissolve in low pH environments, but readily ionize when the pH rises to about 4 or 5, for example synthetic polymers such as polyacids having a pKₐ of 3 to 5.

The enteric coating may be made of any suitable composition. Preferred enteric coating compositions include alkyl and hydroxyalkyl celluloses and their aliphatic esters, e.g., methylcellulose, ethylcellulose, hydroxyethylcellulose, hydroxypropylcellulose, hydroxybutylcellulose, hydroxyethylethylcellulose, hydroxyprophymethylcellulose, hydroxybutylmethylcellulose, hydroxypropylcellulose phthalate, hydroxypropylmethylcellulose phthalate and hydroxypropylmethylcellulose acetate succinate; carboxyalkylcelluloses and their salts, e.g., carboxymethylethylcellulose; cellulose acetate phthalate; cellulose acetate trimellitate, polycarboxymethylene and its salts and derivatives; polyvinyl alcohol and its esters: polyvinyl acetate phthalate; polycarboxymethylene copolymer with sodium formaldehyde carboxylate; acrylic polymers and copolymers, e.g., methacrylic acid-methyl methacrylic acid copolymer and methacrylic acid-methyl acrylate copolymer; edible oils such as peanut oil, palm oil, olive oil and hydrogenated vegetable oils; polyvinylpyrrolidone; polyethylene glycol and its esters; natural products such as shellac, and zein.

Other preferred enteric coatings include polyvinylacetate esters, e.g., polyvinyl acetate phthalate; alkyleneglycolether esters of copolymers such as partial ethylene glycol monomethylether ester of ethylacrylate-maleic anhydride copolymer or diethyleneglycol monomethylether ester of methylacrylate-maleic anhydride copolymer, N-butylacrylate-maleic anhydride copolymer, isobutylacrylate-maleic anhydride copolymer or ethylacrylate-maleic anhydride copolymer; and polypeptides resistant to degradation in the gastric environment, e.g., polyarginine and polylysine. Other suitable coatings and methods to make and use such formulations are well known to those skilled in the art.

Mixtures of two or more of the above compounds may be used as desired. The presently preferred enteric coating comprises cellulose acetate phthalate.

The enteric coating material may be mixed with various excipients including plasticizers such as triethyl citrate, acetyl triethyl citrate, diethyl phthalate, dibutyl phthalate, dibutyl subacute, dibutyl tartrate, dibutyl maleate, dibutyl succinate and diethyl succinate and inert fillers such as chalk or pigments.

The composition and thickness of the enteric coating may be selected to dissolve immediately upon contact with the digestive juice of the intestine. Alternatively, the composition and thickness of the external coating may be selected to be a time-release coating which dissolves over a selected period of time, as is well known in the art.

The amount of enteric coating depends on the particular enteric coating composition used and is preferably sufficient to substantially prevent the absorption of MNTX in the stomach.

Hydroxyalkyl celluloses and their aliphatic esters, carboxyalkyl celluloses and their salts, polycarboxymethylene and its salts and derivatives, polyvinyl alcohol and its esters, polycarboxymethylene copolymer with sodium formaldehyde carboxylates, polyvinylpyrrolidone, and polyethylene glycol and its esters can be applied as enteric coatings by first dissolving the compound in a minimum amount of water. Alcohol is then added to the point of incipient cloudiness. The mixture can then be applied by conventional techniques.

Application of cellulose acetate phthalate may be accomplished by simply dissolving the cellulose acetate phthalate in a minimum amount of alcohol and then applying by conventional techniques. Hydrogenated vegetable oils may be applied by first dissolving the oil in a minimal amount of a non-polymer solvent, such as methylene chloride, chloroform or carbon tetrachloride, then adding alcohol to the point of incipient cloudiness and then applying by conventional techniques.

In one embodiment, the MNTX is coated with Eudragit L100 or S100, a methacrylic acid copolymer enteric coating, at a 50% coating level to provide stability at gastric pH and dissolution at gut pH per a US Pharmacopeia (USP) standard for enteric coatings.

B. MNTX Administration

When used as a treatment in equines for opioid-induced side effects such as constipation and reduction of equine gastrointestinal motility, it is believed that orally or parenterally administered MNTX or other quaternary derivatives of noroxymorphone will provide prolonged relief against such side effects.

Furthermore, for treatment or prevention of equine constipation and delayed gastric emptying, whether caused by extrinsic or endogenous opioids, enteric coating may allow for equal or better efficacy despite lower plasma levels. Idiopathic constipation, i.e., constipation that is due to causes other than exogenous administration of opioids, may be mediated by opioid sensitive mechanisms. Endogenous opioid receptors have been identified in the gut, and these receptors may modulate gut motility. Thus, administration of an opioid antagonist with peripheral action, such a methylnaltrexone or other quaternary derivatives of noroxymorphone, would block the effects of endogenous opioids. Quaternary derivatives of noroxymorphone are described in full in U.S. Pat. No. 4,176,186.

Opioids are typically administered at a morphine equivalent dosage of: 0.005 to 0.15 mg/kg body weight for intrathecal administration; 0.05 to 1.0 mg/kg body weight for intravenous administration; 0.05 to 1.0 mg/kg body weight for intramuscular or subcutaneous administration; and 0.05 to 1.0 mg/kg body weight/hour for transmucosal or transdermal administration. “Morphine equivalent dosage” is meant to represent doses of other opioids which equal one milligram of morphine, for example 10 mg meperidine, 1 mg methadone, and 80 μg fentanyl.

In accordance with the present invention, methylnaltrexone can be administered at a dosage of: 0.05 to 40.0 mg/kg body weight for equine administration, including oral administration of enteric coated methylnaltrexone. Dosages for administering drugs such as methylnaltrexone to equines by suitable administration routes and for suitable time periods, if applicable, otherwise should be apparent to persons skilled in the art.

Multidose treatment also is possible using any of several different modes of administration, for example, in multiple doses (e.g., 3-4 times a day) for up to 4 days.

Methylnaltrexone is preferably administered, in one embodiment, prior to administration of an exogenous opioid, and in another embodiment, prior to the onset of symptoms caused by endogenous opioids, to prevent opioid-induced gastrointestinal dysfunction, such as inhibition of gastrointestinal motility or constipation. It is desirable to begin internal administration of methylnaltrexone about 20 minutes prior to administering exogenous opioids in order to prevent opioid-induced side effects. While the prevention of symptoms is preferred, methylnaltrexone may also be administered after the administration of an exogenous opioid or after the onset of opioid (exogenous or endogenous)-induced symptoms as a treatment for those symptoms.

Methylnaltrexone is rapidly absorbed after oral administration from the stomach and bowel. Initial plasma levels of the drug are seen within 5-10 minutes of the administration of non-enteric coated compound. Addition of an enteric coating which prevents gastric absorption is associated with lower plasma levels of the methylnaltrexone. Surprisingly, the addition of an enteric coating (i.e., a coating which will prevent degradation or release in the stomach, but will release drug in the small and large bowel) was shown in humans to enhance the efficacy of methylnaltrexone in preventing decreases in gut motility by intravenously administered opioids such as morphine.

For intravenous or, more generally, parenteral administration, methylnaltrexone is formulated with saline or other physiologically acceptable carriers; e.g., for intramuscular administration, the methylnaltrexone is formulated with saline or other pharmacologically acceptable carriers; while for transmucosal administration the methylnaltrexone is formulated with a sugar and cellulose mix or other pharmacologically acceptable carriers known in the art. For oral administration, the methylnaltrexone may be formulated with pharmacologically acceptable binders to make a tablet or capsule with or without an enteric coating. Methods for such formulations are well known to those skilled in the art.

Other modes for administrating MNTX, which use formulations similar to that used for intravenous administration, include epidural, spinal, catheter, peritoneal, and subcutaneous administration.

For transdermal administration, any art-known transdermal application may be used, including using a patch applied to the skin with a membrane of sufficient permeability to allow diffusion of MNTX at a fixed rate in the range of 1.0 to 10.0 mg/hr. The rate of administration may be varied by varying the size of the membrane contact area and/or applying an electrical wiring potential to a drug reservoir. The patch preferably holds 25 mg to 1 gram of available drug in the reservoir plus additional drug as needed for the mechanics of the system.

In the above description, methylnaltrexone is an example of a particularly effective peripheral opiate antagonist. It is apparent that other peripheral opiate antagonists, such as alvimpan, also may be used as desired. MNTX may also be administered in combination with certain opioids as an analgesic.

Based on its properties, MNTX is suitable for situations such as the ones listed above. Administering MNTX in conjunction with opioids (exogenous or endogenous), or the side effects caused by such opioids, should alleviate or prevent pain in horses while also treating or preventing their constipation and other possible side effects by reducing levels of β-endorphins in the plasma, or reversing the effects of endogenous opioids having mu activity.

The publications and other materials used herein to illuminate the background of the invention, and provide additional details respecting the practice of the invention, are incorporated herein by reference as if each was individually incorporated herein by reference.

While the invention has been disclosed in this patent application by reference to the details of preferred embodiments of the invention, it is to be understood that the disclosure is intended in an illustrative rather than in a limiting sense, as it is contemplated that modifications will readily occur to those skilled in the art, within the spirit of the invention and the scope of the

1. A method for treating or preventing gastrointestinal dysfunction in an equine induced by elevated concentrations of endogenous opioids, while maintaining the pain-reducing effects of the opioids, comprising administering an effective amount of methylnaltrexone to the equine before or after the onset of the gastrointestinal dysfunction, thereby treating or preventing the gastrointestinal dysfunction without precipitating pain in the equine.

2. The method of claim 1, wherein the methylnaltrexone is administered intravenously, intramuscularly, or subcutaneously.

3. The method of claim 2, wherein the methylnaltrexone is administered subcutaneously.

4. The method of claim 1, wherein the methylnaltrexone is administered at a dosage of 0.05 to 40.0 mg of active drug per kg body weight.

5. The method of claim 1, wherein the gastrointestinal dysfunction is constipation or reduced frequency of Taxation.

6. The method of claim 1, wherein the gastrointestinal dysfunction is delayed gastric emptying and resultant reflux.

7. The method of claim 1, wherein the gastrointestinal dysfunction is equine colic.

8. The method of claim 1, wherein the gastrointestinal dysfunction is post-operative ileus.

9. The method of claim 1, wherein the gastrointestinal dysfunction is grass sickness.

10. The method of claim 1, wherein the gastrointestinal dysfunction induced by elevated concentrations of endogenous opioids occurs during transport.

11. A method for relieving inhibition of gastrointestinal motility in an equine induced by elevated concentrations of endogenous opioids, while maintaining the pain-reducing effects of the opioids, comprising administering an effective amount of methylnaltrexone to the equine, thereby relieving the inhibition of gastrointestinal motility without precipitating pain in the equine.

12. A method for minimizing the onset of side effects induced by elevated concentrations of endogenous opioids in an equine, while maintaining the pain-reducing effects of the opioids, comprising administering an effective amount of methylnaltrexone to the equine.

13. The method of claim 11, wherein the side effect is shock.

14. A method for treating or preventing inhibition of gastrointestinal motility induced by elevated concentrations of endogenous opioids in an equine during transport of the equine, while maintaining the pain-reducing effects of the opioids, comprising administering an effective amount of methylnaltrexone to the equine, thereby treating or preventing the inhibition of gastrointestinal motility.
